(19) United States
(12) Patent Application Publication
(10) Pub. No.: US 2009/0178812 A1
(43) Pub. Date: Jul. 16, 2009

(54) Systems and methods using vacuum-induced mixing with a venturi nozzle

(76) Inventors: Jason David Solomon, Troy, OH (US); Marvin Rosenberg, Cincinnati, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 11/633,664

(22) Filed: Dec. 4, 2006

Related U.S. Application Data
(60) Provisional application No. 60/777,611, filed on Feb. 28, 2006.

(51) Int. Cl. A62C 31/02; A62C 35/00

(52) U.S. Cl. 169/14; 239/428.5

(57) ABSTRACT

A venturi nozzle producing a stream of aerated water containing air-entrained bubbles. The stream of aerated water containing air-entrained bubbles may be directed onto a fire to extinguish the fire. Water entering the venturi nozzle may be mixed with a fluid substance, such as a foam-producing substance, gas, or powdered substance suspended in air, and the mixture may be ejected from the nozzle. Embodiments of the venturi nozzle including a fire-fighting nozzle, a sprinkler head, and an array of sprinklers are described.

### CROSS REFERENCE TO RELATED APPLICATION

This application claims the benefit of U.S. Provisional Patent Application No. 60/777,611 filed on Feb. 28, 2006, the disclosure of which is incorporated herein by reference.

### BACKGROUND

The present invention relates to vacuum-induced mixing with a venturi nozzle. More particularly, systems and methods using a venturi nozzle to mix water with air and other substances are described.

### SUMMARY

In a first aspect, the present invention venturi nozzle may include a channel with a section of narrower width than the surrounding sections, an air inlet through which air can enter the channel, and an internal baffle in the channel around which water flowing through the channel can pass such that water entering the venturi nozzle is mixed with air and the mixture is ejected from the venturi nozzle producing a stream of aerated water containing air-entrained bubbles. The stream of aerated water containing air-entrained bubbles may be directed onto a fire to extinguish the fire.

In a second aspect, the present invention venturi nozzle may include a channel with a section of narrower width than the surrounding sections, an air inlet through which a fluid substance can enter the channel, and an internal baffle in the channel around which water flowing through the channel can pass such that water entering the venturi nozzle is mixed with the fluid substance and such mixture is ejected from the venturi nozzle. The fluid substance may be a foam substance containing suspended encapsulated air.

In a third aspect, the present invention firefighting nozzle may include a channel having a section of narrower width than the surrounding sections, an air inlet through which air can enter the channel, and an internal baffle in the channel around which water flowing through the channel can pass such that water entering the venturi nozzle is mixed with air and the mixture is ejected from the venturi nozzle producing a stream of aerated water containing air-entrained bubbles which may be directed onto a fire to extinguish the fire.

In a fourth aspect, the present invention fire sprinkler may include a venturi nozzle having a channel including a section of narrower width than the surrounding sections, an air inlet through which air can enter the channel, and an internal baffle in the channel around which water flowing through the channel can pass such that water entering the venturi nozzle is mixed with air producing aerated water containing air-entrained bubbles which is ejected from the venturi nozzle. A sprinkler head may be coupled to the venturi nozzle at the point where the mixture is ejected from the venturi nozzle, the sprinkler head being adapted to spread the mixture over a relatively wider area such that the mixture of aerated water containing air-entrained bubbles may be sprayed onto a fire to extinguish the fire. The fire sprinkler may further include a source of foam in fluid communication with the air inlet such that the foam may be mixed with the water to produce aerated water containing air-entrained bubbles and foam and the mixture of aerated water containing air-entrained bubbles and foam may be sprayed onto a fire to extinguish the fire.

In a fifth aspect, the present invention array of fire sprinklers may include a plurality of fire sprinklers. Each fire sprinkler may include a venturi nozzle having a channel with a section of narrower width than the surrounding sections, an air inlet through which air can enter the channel, and an internal baffle in the channel around which water flowing through the channel can pass such that water entering the venturi nozzle is mixed with air to produce aerated water containing air-entrained bubbles and such that the mixture is ejected from the venturi nozzle; and a sprinkler head coupled to the venturi nozzle at the point where the mixture is ejected from the venturi nozzle, the sprinkler head being adapted to spread the mixture over a relatively wider area and a source of foam in fluid communication with each of the plurality of air inlets such that each of the venturi nozzles is in fluid communication with a common supply of water such that the foam is mixed with the water in each of the venturi nozzles to produce aerated water containing air-entrained bubbles and foam which may be sprayed onto a fire to extinguish the fire.

### BRIEF DESCRIPTION OF THE DRAWINGS

FIG. 1 shows the venturi nozzle, according to an exemplary embodiment of the present invention.

FIG. 2 shows the venturi nozzle in a firefighting application, according to an exemplary embodiment of the present invention.

FIG. 3 shows the venturi nozzle with a sprayer attachment, according to an exemplary embodiment of the present invention.

FIG. 4 shows the venturi nozzle in a firefighting sprinkler application, according to an exemplary embodiment of the present invention.

FIG. 5 shows a plurality of venturi nozzles in a firefighting sprinkler application, according to an exemplary embodiment of the present invention.

### DETAILED DESCRIPTION

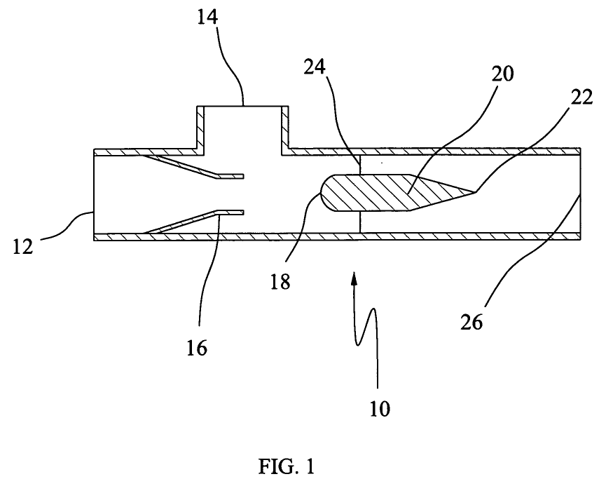

FIG. 1 shows a side cutaway view of a venturi nozzle 10, according to an exemplary embodiment of the present invention. Water is supplied to the venturi nozzle 10 through inlet 12, and the water flow velocity is increased as the water passes through the channel 16. The narrowed stream of water emerging from the channel 16 strikes the butt end 18 of the baffle 20, which is held in place by radial stays 24. Upon striking the butt end 18, the water is dispersed into the annular region surrounding the baffle 20. The dispersion of the water creates a partial vacuum in the region between the channel 16 and the baffle 20, and air is drawn in through port 14. The water and air pass around the baffle 20 through the annular region, and over the pointed end 22 of the baffle 20. The turbulence resulting from the pass around the baffle 20 mixes the air with the water. The aerated water then exits the venturi nozzle 10 through opening 26. In an exemplary embodiment, the overall diameter of the nozzle body is 40 mm (1.6 inches), the pointed end 22 of the baffle 20 is tapered with an angle of 30 degrees, the baffle 20 has an overall length of 76 mm (3 inches) with the tapered portion being 25 mm (1 inch) long, the butt end 18 of the baffle 20 is located 18 mm (0.7 inches) away from the end of the channel 16 from which water emerges, and the channel 16 and baffle 20 each have a diameter of 19 mm (0.75 inches). In an alternative embodiment, the overall diameter of the nozzle body is 51 mm (2.0 inches), the channel 16 and baffle 20 each have a diameter of 25 mm (1.0 inch), and the other measurements have the same values as in the first embodiment described above. In additional embodiments, other values for these parameters could be used to achieve the desired performance and mixing characteristics, as will be appreciated by persons skilled in the art.

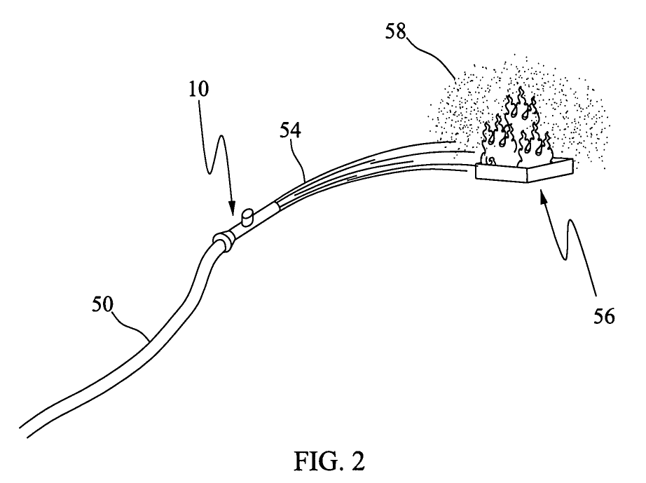

FIG. 2 shows the venturi nozzle 10 being used in a firefighting application. Water is supplied by a fire hose 50 connected to the venturi nozzle 10. The water is mixed with air by the venturi nozzle as described above, and a stream of aerated water 54 exits the venturi nozzle. When the stream of aerated water 54 is directed onto a fire 56, the water rapidly flashes to steam. The water/air mixture in the stream 54 contains tiny air-entrained bubbles in a balance, which allow heat to be transferred to the water much more rapidly than would be possible with non-aerated water. As the water flashes to steam, a cloud 58 of steam and condensation envelops the fire 56, rapidly extinguishing the fire. Additionally, the vaporization of the aerated water results in a rapid loss of heat from the fire, which further speeds up the fire extinguishing process. Use of the venturi nozzle 10 as a firefighting nozzle has the further advantage of producing less recoil force when operated due to the reduced mass flow rate of water needed. This, in turn, allows the hose and nozzle to be operated with fewer firefighters or a less massive support apparatus to hold it in place.

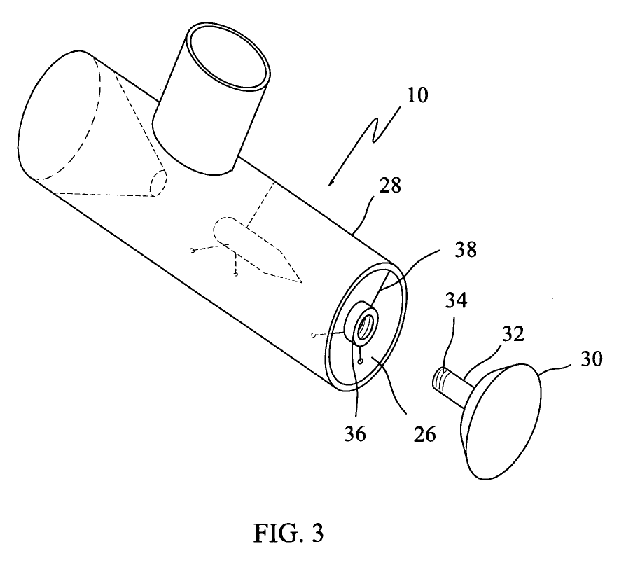

FIG. 3 shows the venturi nozzle 10 equipped with a sprayer 30 to finely disperse the water/air mixture that exits the venturi nozzle, according to an exemplary embodiment of the present invention. The sprayer 30 includes a tapered disc having a maximum diameter that is approximately equal to the diameter of the exit orifice 26 of the nozzle body 28. The disc of the sprayer 30 has a bolt 32 with a threaded end 34. This threaded end 34 can be threaded into a hub 36 that is held in place along the longitudinal centerline of the nozzle body 28 by radial stays 38. As the water/air mixture exits the venturi nozzle 10 through the exit orifice 26, it is deflected by the sprayer 30, producing a relatively fine mist. This sprayer attachment can be used with the venturi nozzle in a variety of applications, some of which are described below, where it is desired to obtain a fine spray or mist of water-air mixture exiting the venturi nozzle.

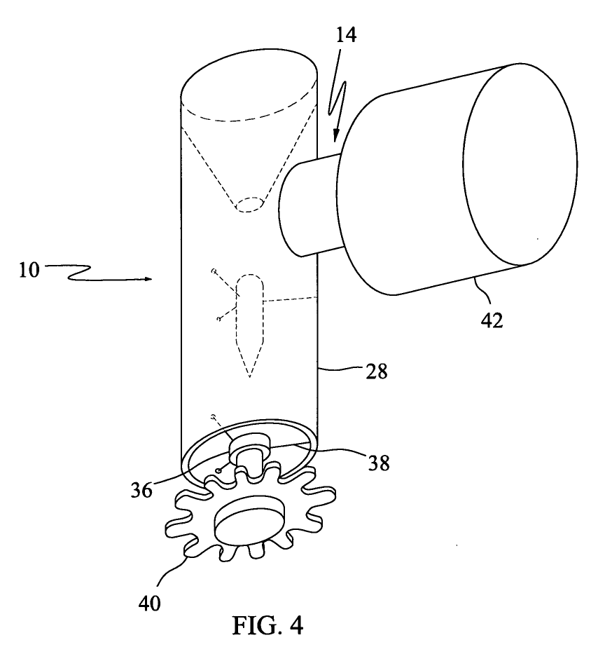

FIG. 4 shows the venturi nozzle 10 fitted with a sprinkler head 40. The sprinkler head 40 can be fitted to the venturi nozzle 10 in the same manner as the sprayer described above with reference to FIG. 3. This embodiment allows the venturi nozzle, with its aerating function, to be employed for emergency fire sprinkler units. A reservoir 42 may be connected in fluid communication with the venturi nozzle's air intake port 14 to provide a source of foam or other substance to aid in fire suppression. The foam or other substance contained in the reservoir 42 will be drawn into the venturi nozzle by the vacuum effect described above, where it will be mixed with water and expelled over the sprinkler head 40, which spreads the mixture over a wider area. Because foam contains encapsulated air suspended in the substance and therefore has a relatively low density, it is an ideal form for a substance to be mixed using the vacuum-induced mixing of the venturi nozzle. The supply of water can be activated in response to detection of a fire or other hazard in a manner known to persons skilled in the art.

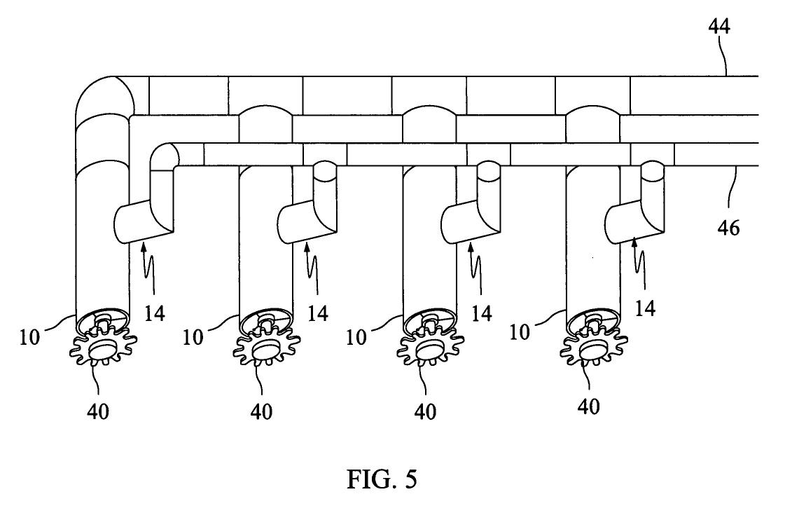

FIG. 5 shows an embodiment in which a plurality of venturi nozzles 10, each fitted with a sprinkler head 40, have been connected to common supply lines. Water is supplied to each venturi nozzle 10 by a common water supply line 44. The air intake ports 14 of the venturi nozzles 10 have been connected to a common supply line 46. The supply line 46 can be connected to a reservoir or source of foam or other substance to be mixed with the water to aid in fire suppression, as discussed above.

In another embodiment, the venturi nozzle described herein can be used in a variety of applications where the mixing of fluid substances is desired. For example, many industrial and manufacturing processes involve the mixing or application of foam-based products, such as insulation. In addition to foam-based products, the venturi nozzle can be used to mix water or another liquid with any gas, or with another liquid, or with a finely-ground or powdered substance suspended in air.

In another embodiment, the venturi nozzle described herein can be used for aeration of a pond, aquarium, or other reservoir where increased concentration of oxygen is desired. The mixing of air with water by the venturi nozzle produces an air-rich stream, as discussed above. When this air-rich stream is directed to a body of water, oxygen in the air-rich stream dissolves in the water, thus increasing the concentration of dissolved oxygen in the water.

Following from the above description and invention summaries, it should be apparent to persons of ordinary skill in the art that, while the methods and apparatuses herein described constitute exemplary embodiments of the present invention, it is to be understood that the inventions contained herein are not limited to the above precise embodiments and that changes may be made without departing from the scope of the invention as defined by the following proposed points of novelty. Likewise, it is to be understood that it is not necessary to meet any or all of the identified advantages or objects of the invention disclosed herein in order to fall within the scope of the invention, since inherent and/or unforeseen advantages of the present invention may exist even though they may not have been explicitly discussed herein.

What is claimed is:

1. A venturi nozzle comprising:
(a) a channel including a section of narrower width than the surrounding sections;
(b) an air inlet through which air can enter the channel; and
(c) an internal baffle in the channel around which water flowing through the channel can pass;
whereby water entering the venturi nozzle is mixed with air, and such mixture is ejected from the venturi nozzle; wherein
a stream of aerated water containing air-entrained bubbles is produced.

2. The venturi nozzle of claim 1, wherein
the stream of aerated water containing air-entrained bubbles is directed onto a fire to extinguish the fire.

3. A venturi nozzle comprising:
(a) a channel including a section of narrower width than the surrounding sections;
(b) an air inlet through which a fluid substance can enter the channel; and
(c) an internal baffle in the channel around which water flowing through the channel can pass;
whereby water entering the venturi nozzle is mixed with the fluid substance, and such mixture is ejected from the venturi nozzle; wherein
a mixture containing water and the fluid substance is produced.

4. The venturi nozzle of claim 3, wherein
the fluid substance is a foam substance containing encapsulated air suspended therein.

5. A firefighting nozzle comprising:
(a) a channel including a section of narrower width than the surrounding sections;
(b) an air inlet through which air can enter the channel; and
(c) an internal baffle in the channel around which water flowing through the channel can pass;
whereby water entering the venturi nozzle is mixed with air, and such mixture is ejected from the venturi nozzle; wherein
a stream of aerated water containing air-entrained bubbles is produced; and wherein
the stream of aerated water containing air-entrained bubbles is directed onto a fire to extinguish the fire.

6. A fire sprinkler comprising:
a venturi nozzle having a channel including a section of narrower width than the surrounding sections; an air inlet through which air can enter the channel; and an internal baffle in the channel around which water flowing through the channel can pass; whereby water entering the venturi nozzle is mixed with air to produce aerated water containing air-entrained bubbles and such mixture is ejected from the venturi nozzle; and
a sprinkler head coupled to the venturi nozzle at the point where the mixture is ejected from the venturi nozzle, the sprinkler head being adapted to spread the mixture over a relatively wider area; wherein
the mixture of aerated water containing air-entrained bubbles is sprayed onto a fire to extinguish the fire.

7. The fire sprinkler of claim 6, further comprising:
a source of foam in fluid communication with the air inlet, wherein
the foam is mixed with the water to produce aerated water containing air-entrained bubbles and foam; and wherein
the mixture of aerated water containing air-entrained bubbles and foam is sprayed onto a fire to extinguish the fire.

8. An array of fire sprinklers comprising:
a plurality of fire sprinklers, each fire sprinkler comprising: (a) a venturi nozzle having a channel including a section of narrower width than the surrounding sections; an air inlet through which air can enter the channel; and an internal baffle in the channel around which water flowing through the channel can pass; whereby water entering the venturi nozzle is mixed with air to produce aerated water containing air-entrained bubbles and such mixture is ejected from the venturi nozzle; and (b) a sprinkler head coupled to the venturi nozzle at the point where the mixture is ejected from the venturi nozzle, the sprinkler head being adapted to spread the mixture over a relatively wider area; and
a source of foam in fluid communication with each of the plurality of air inlets, wherein
each of the plurality of venturi nozzles is in fluid communication with a common supply of water; and wherein
the foam is mixed with the water in each of the plurality of venturi nozzles to produce aerated water containing air-entrained bubbles and foam; and wherein
the mixture of aerated water containing air-entrained bubbles is sprayed onto a fire to extinguish the fire.
